(19) United States
(12) Patent Application Publication
(10) Pub. No.: US 2004/0046526 A1
(43) Pub. Date: Mar. 11, 2004

(54) Modular fuel cell

(76) Inventor: William R. Richards, Springfield, VA (US)

Correspondence Address: MATTINGLY, STANGER & MALUR, P.C., 1800 DIAGONAL ROAD, SUITE 370, ALEXANDRIA, VA, 22314, US

(21) Appl. No.: 10/656,824

(22) Filed: Sep. 8, 2003

Related U.S. Application Data
(60) Provisional application No. 60/408,335, filed on Sep. 6, 2002.
(60) Provisional application No. 60/425,242, filed on Nov. 12, 2002.

(51) Int. Cl. H02J 7/00

(52) U.S. Cl. 320/101

(57) ABSTRACT

Fuel cell modules are assembled in receiver sections of an assembly in a power generation system. Both fuel and reactant gas feed and return lines provide leak-tight shutoff of all porting connections to the modular fuel cell by using failsafe (spring-loaded to the closed or “off” position) cartridge-type plug valves in the headers. The fuel and air ports of gas distribution manifolds on the ends of the module connect to distribution headers using a low compression face seal that is maintained in compression by providing tapered mating surfaces between the manifolds and headers. Through the insertion of a module in a receiving section, the flow control valves are actuated at the header distribution ports, the manifold ports are aligned with the header ports with their seals placed in compression and an electrical connection is established between electrical plugs protruding from the module and the base of the receiving section.

### CROSS-REFERENCES TO RELATED APPLICATIONS

This application claims the benefit of U.S. Provisional Patent Application No. 60/408,335, filed Sep. 6, 2002 and U.S. Provisional Patent Application No. 60/425,242, filed Nov. 12, 2002.

### BACKGROUND OF THE INVENTION

1. Field of the Invention

The present invention is directed to a fuel cell module and modular fuel cell that can be configured in an assembly having module components capable of being easily removed and replaced. As a preferred embodiment, the module components are capable of being replaced and removed while the fuel cell stack is under electrical load. This provides continuous duty/un-interruptible operation of a series and/or parallel fuel cell stack configuration comprised of the modules of the present invention.

2. Description of the Related Art

PEM fuel cells are used for power generation and each of the fuel cells has fuel and air requirements for operation. When a number of individual fuel cells are assembled together to constitute a module, problems can develop with the modules, and in particular with the supply of fuel (H₂) and air, as well as with heat dissipation and power collection. In U.S. Pat. No. 6,030,718, a PEM fuel cell power system is disclosed that enables individual fuel cell modules to be connected to racks within a housing. The modules have a hydrogen distribution rack with a terminal end that engages a valve on the rack that supplies hydrogen gas to the module. The rack or housing has many slots and each slot accepts a module. Accordingly, there are valves for supplying hydrogen gas and a return for each slot.

### BRIEF SUMMARY OF THE INVENTION

According to the present invention, a “modular”, “building-block” array of nominal 1-kW output capacity fuel cell assemblies is provided. The modular fuel cell blocks may be individually removed and/or replaced in an array or assembly that enables continuous operation without interruption or significant disruption of the power supplied by the assembly.

It is an objective to provide a lightweight (less than 10#) and easily held fuel cell assembly of nominal 1-kW output capacity, that may be gripped with ease and minimal force applied, to accomplish the safe removal and/or replacement of “modular” fuel cell assembly from a similar “modular” manifold block assembly.

It is a further object to provide the “modular” manifold block assembly with such features that both fuel and reactant gas feed and return lines provide positive, leak-tight shutoff and/or isolation of all porting connections to/from the “modular” fuel cell assembly, by the employment of Failsafe (Spring-Loaded to Close or “Off” Position) “On-Off” control action cartridge-type plug valve (or similar), and as effected by operator access to the exposed front face (accessible portion) of the 1-kW fuel cell assembly.

It is a further object to provide the “modular” manifold block assembly with nominal 1-kW output capacity with such features to assure that associated electrical loads may be safely and reliably disconnected and subsequently reconnected, by the consideration of “make-break” current levels being constrained to values of approximately twenty (25), up to a maximum of fifty (50) amperes per electrical plug connection.

It is a further object to provide the “modular” manifold block assembly with features to allow porting and distribution exhaust reactant gas flows uniformly over the exposed periphery of the fuel cell assembly, such that convective air cooling measures may be effected, and in conjunction with water management/cooling processes within the fuel cell stack assembly envelope, shall limit the maximum external surface temperatures, and thereby allow for the safe removal of said fuel cell stack assembly by “hand” without discomfort.

It is a further object to provide the fuel cell stack assembly with internal fuel and reactant gas distribution features such that both the fuel cell stack electrical output capability is maximized, and the internal water management/cooling processes are facilitated. This object may be accomplished, in a preferred embodiment of the invention, by the use of slotted versus circular internal gas distribution supply and return passages, and tapered distribution headers, and thereby allowing for the lowest possible velocity head losses, and the highest possible uniformity (laminar flow) in gas flow volumes to/from all active unit area increments of the conductive (electro-chemically active) region of the fuel cell stack assembly.

It is a further object to provide a uniform compressive clamping force within the conductive (electro-chemically active) region of the fuel cell stack assembly, such that associated contact voltage drop effects are minimized, and which results in the achievement of optimal resistivity performance of the Gas Diffusion Media, and which therefore yields the greatest possible output power versus internal heat generated.

It is a further object to provide all of the above features in a freestanding array consisting of symmetric 1-kW “modular” fuel cell stacks capable of being installed in a series manifold of up to twenty (20) “plug-in” elements, thereby allowing capability to operate at 480 VDC, and via symmetric configuration, yielding capability to provide up to 40-kW per array. The envelope of this freestanding array of 1-kW “modular” fuel cell assemblies would be less than 9.75″ W×80.0″ H×12.0″ Dp. Larger-sized output capacity arrays would be accomplished by mounting of these freestanding arrays in parallel to realize units with 240-kW (and larger) output capacities and providing a very small footprint.

It is yet a further object to provide such large-scale arrays with Preventative Maintenance/Fault-Location (PM/FL) features, to facilitate the rapid location of defective fuel cell assemblies, such that they may be rapidly removed and replaced. These features would preferably consist of the threshold detection of increased temperature levels within the individual 1-kW module, such that illumination of LEDs would indicated the operating status. By way of example, Green would indicate operation within room (or ambient) temperature up to 150 Deg. F., Yellow would indicate incipient failure at greater than 150 Deg. F. for 10 minutes of longer, and Red for temperatures of greater than 180 Deg. F. Both local and remote alarms would be triggered based upon performance/operational necessity and safety considerations.

It is a further object of the invention to include a bipolar plate configuration, in accordance with embodiments of the present invention, having tapered-width micro-channel grooving, which provides a significantly improved level of fuel and reactant gas distribution uniformity over the active area of an individual cell itself, between a plurality of cells within a fuel cell module.

The modular fuel cell of the present invention that includes the bipolar plates having tapered-width micro-channel grooving facilitates the achievement of substantially reduced concentration gradient variations over any subject unit area of the active region of a cell (also minimizing gas flow volume/gas velocity variations per unit area), thereby maximizes the vaporization capability of the reactant gas stream, and which subsequently minimizes development of “hot-spots.”

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated, wherein:

FIG. 1 is a perspective view of a plurality of fuel cell modules in an assembly for power generation configured in which the fuel cell modules ban be easily removed and replaced;

FIG. 2 is a top view of the fuel cell modules in the assembly shown in FIG. 1;

FIG. 3 is a side view of a plurality of fuel cell modules in the assembly shown in FIG. 1;

FIG. 4 is a top view of a fuel cell module according to the present invention and as shown in FIG. 1.

FIG. 5 is an end view of the fuel cell module shown in FIG. 4 that shows the front mating face of a gas distribution manifold of the module.

FIG. 6 is a view of the back mating face of the gas distribution manifold shown in FIG. 5.

FIG. 7 is a sectional view taken along line 7-7 in FIG. 6.

FIG. 8 is an end view of one of the collector plates used for the fuel cell module shown in FIG. 1;

FIG. 9 is a sectional view taken along line 9-9 in FIG. 8.

FIG. 10 is an exploded perspective view of the inside portions of a PEM fuel cell building-block module according to another embodiment of the invention with the end plates not shown to enable the internal components of the fuel cell to identified.

FIG. 11 is one side view of a bipolar plate showing the anode side gas feed groove pattern.

FIG. 12 is a sectional view of the bipolar plate shown in FIG. 11 taken along line 12-12.

FIG. 13 is the opposite side view of the bipolar plate of FIG. 11 showing the cathode side gas feed groove pattern.

FIG. 14 is a sectional view of the bipolar plate shown in FIG. 11 taken along line 14-14.

### DETAILED DESCRIPTION OF THE INVENTION

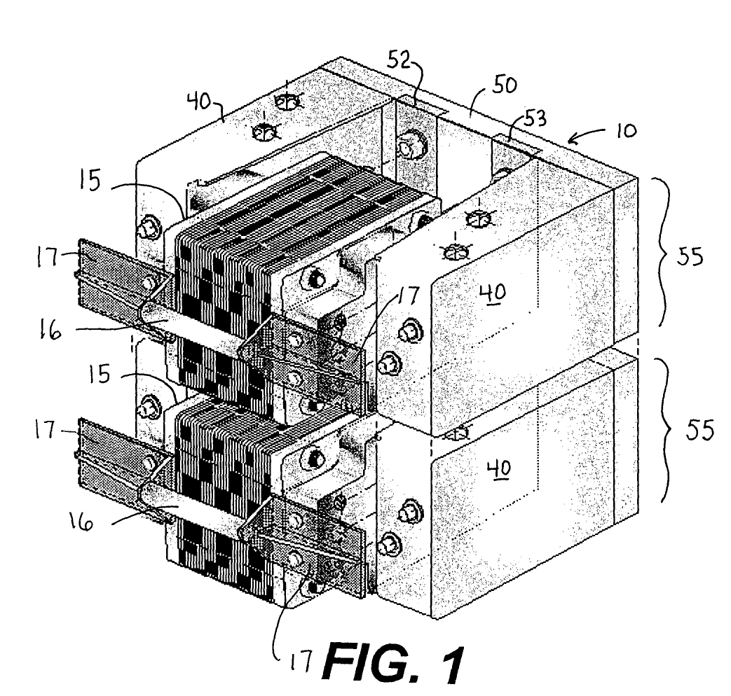

FIG. 1 is a perspective view of a plurality of fuel cell module 15 in an assembly 10 for power generation configured in which the fuel cell module 15 ban be easily removed and replaced. In particular, a basic multi-cell module 15 with modified manifold/collector plates is shown. In order to affect a full “hot-swappable” capability, in accordance with an embodiment of the present invention, the module 15 can be added and removed from an assembly having headers and a base plate. A nominal approximate 4° tapered non conductive manifold block is provided on each end face of the module 15, such that positive sealing of a make/break face-seal with O-Ring glands may be accomplished simultaneously with inserting or removing of the module 15 in a receiver section 55 to be explained in greater detail.

The base 50 of assembly 10 has bus strips 52 and 53 for the cathode and anode connections to the fuel cell modules 15. n The length of the base and the number of receiving sections 55 determines the overall array of fuel cell modules 15. Preferably, the fuel cell modules 15 are disposed in a vertically extending array by mounting the base to a vertical support structure through mounting arrangement, not shown. Further, the output power is taken from the array or assembly of fuel cell modules 15 by connection with bus strips 52 and 53.

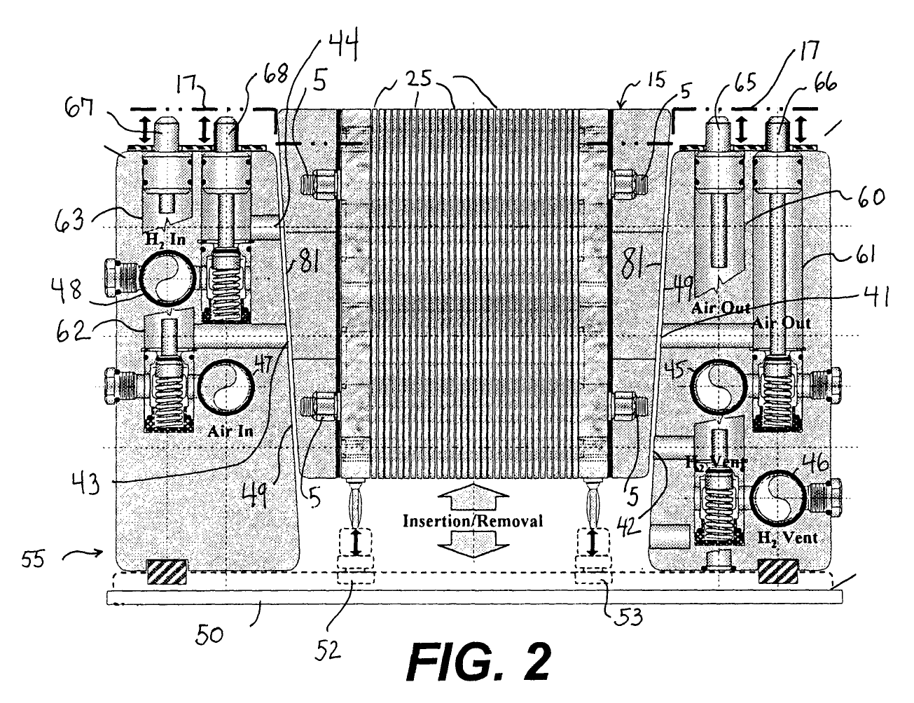

Referring to FIG. 2, plunger-actuated “failsafe” cartridge check valves 60 (H₂ vent), 61 (air out), 62 (air in) and 63 (H₂ in) are provided for the make/break isolation of both fuel (H₂) and reactant gas (air) connections. This ensures a low (e.g., <10#) insertion/removal force associated with the insertion/removal of the module 15 with respect to the assembly. Any practical number of fuel cell modules 15 can be assembled together in the manner shown in the figure. Parallel stacking of 10-20 1.0-kW Modules 15 is preferred depending on flow provided through the primary gas distribution headers within the receiver sections 55. The exhaust air flow of each respective module 15 provides external cooling by redirection of this air flow over the external (exposed) bipolar plates 90 in the module 15 or fuel cell stack. Further, the capability is provided to achieve a positive orientation and alignment of a fuel cell module 15 within its respective receiver via the use of keyed relief features and placement of electrical plug receptacles 79 to generate an interference if the orientation is incorrect. According to the invention, a plurality of modules 15 are connected electrically in series to generate a DC voltage output capability that depends on the number of fuel cells that are in the assembly.

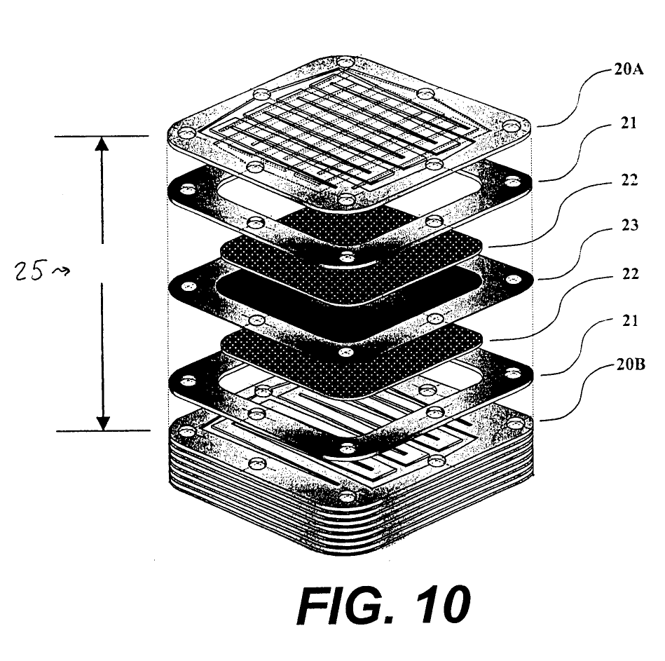

FIG. 2 shows an example of as complete 1-kW fuel cell module 15 coupled with a receiver section 55, in accordance with an embodiment of the present invention. The fuel cell module 15 consists of a stack of fuel cells 25, shown in greater detail in FIG. 10. The stack is bolted together with tie rods 5 having end nuts. At the front of each module 15 is a handle 16 having projected end pieces 17 (shown schematically in FIG. 2). End pieces 17 engage the actuators 65-68 of the valves 60-63 when the module 15 is inserted in the receiver section 55. Since the valves are normally spring biased in the closed position, the gas and air is supplied through the respective ports 41-44 in headers 40, which are connected to the appropriate gas supply through common piping 45-48 or ports (shown plugged).

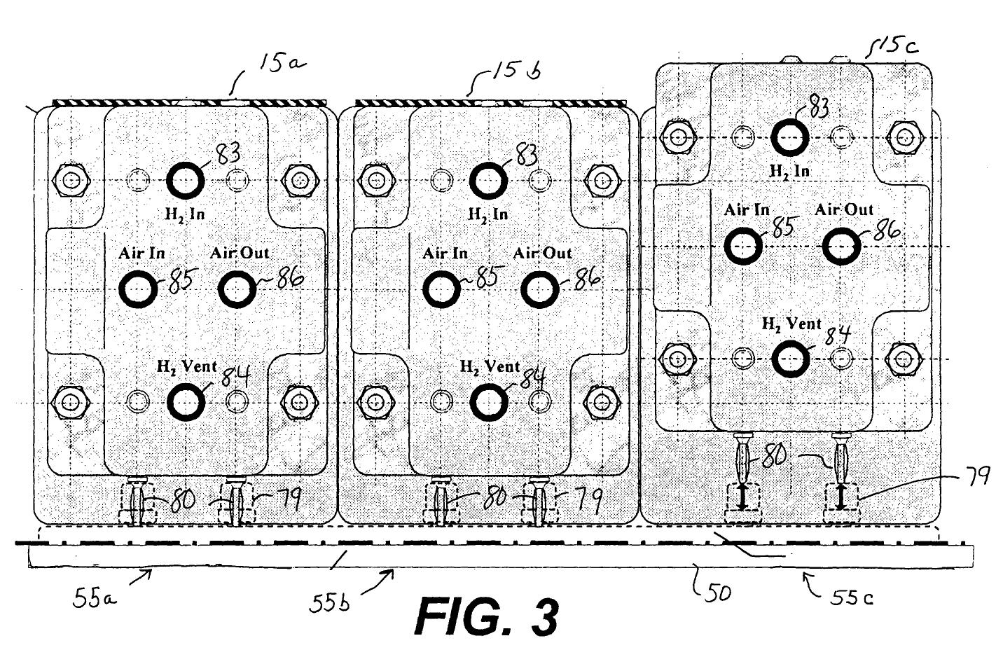

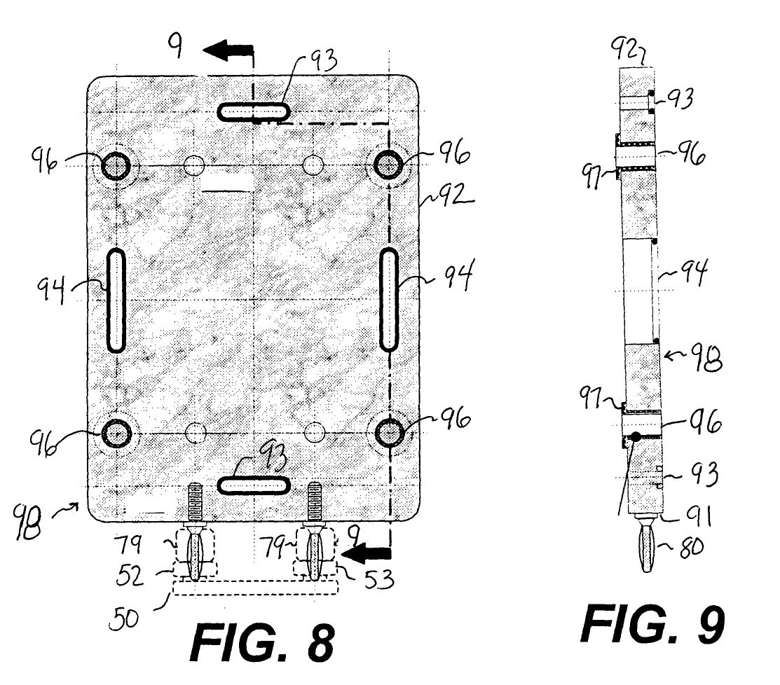

FIG. 3 is a side view of three fuel cell modules 15a, 15b and 15c with two of the modules 15a, 15b seated within the respective receiver sections 55a, 55b and with a third module 15c aligned with the receiver section 55c and not fully seated. The electrical plugs 80 that are shown for the modules 15 are fixed on the collector plate 98 as shown in FIGS. 8 and 9. The plugs may be banana plugs or an equivalent plug that enables electrical connection with the base and that also preferably secures the module 15 in place. Alternatively, the plug may be a spade type that is received within the receiver section in combination with a locking device that holds the module 15 in place. Further, a combination of the banana plugs and a separate locking device can be used to secure the modules 15 in place.

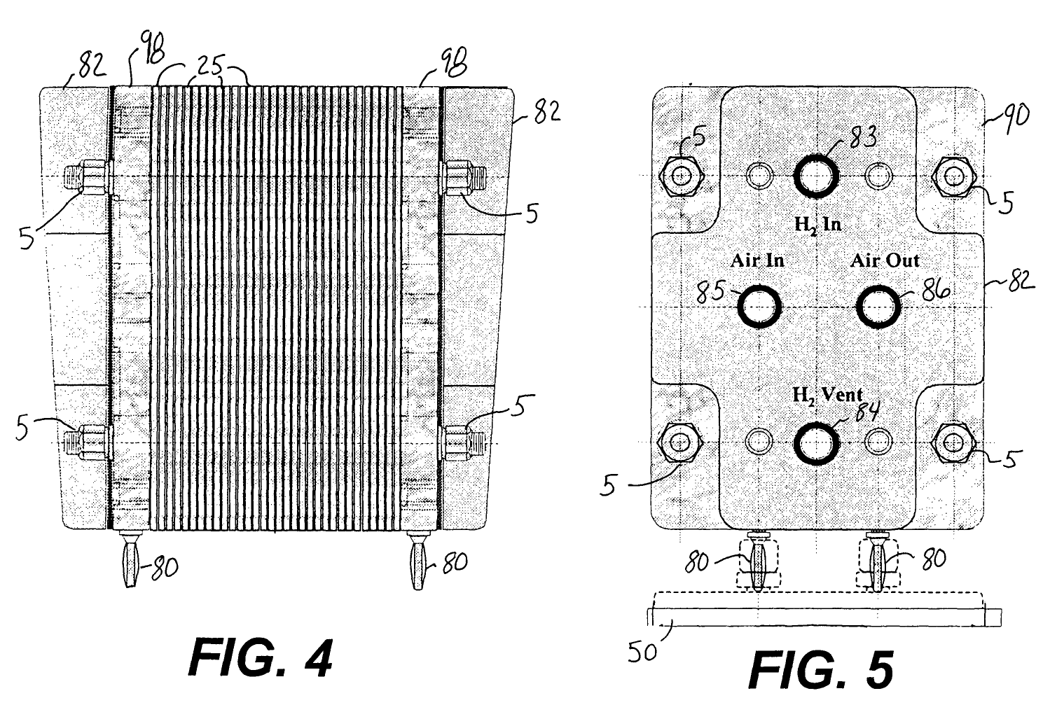

FIG. 4 is a top view of the fuel cell module 15 according to the present invention. Tie rods 5 are shown holding the stack of fuel cells 25 together between end plates 98. The taper of gas distribution manifolds 82 is shown, which is preferably 4°, or within a range of taper that permits the engagement of the seals for the gas and air connections without excessive force, while maintaining a force against the seals that ensures gas tight connection.

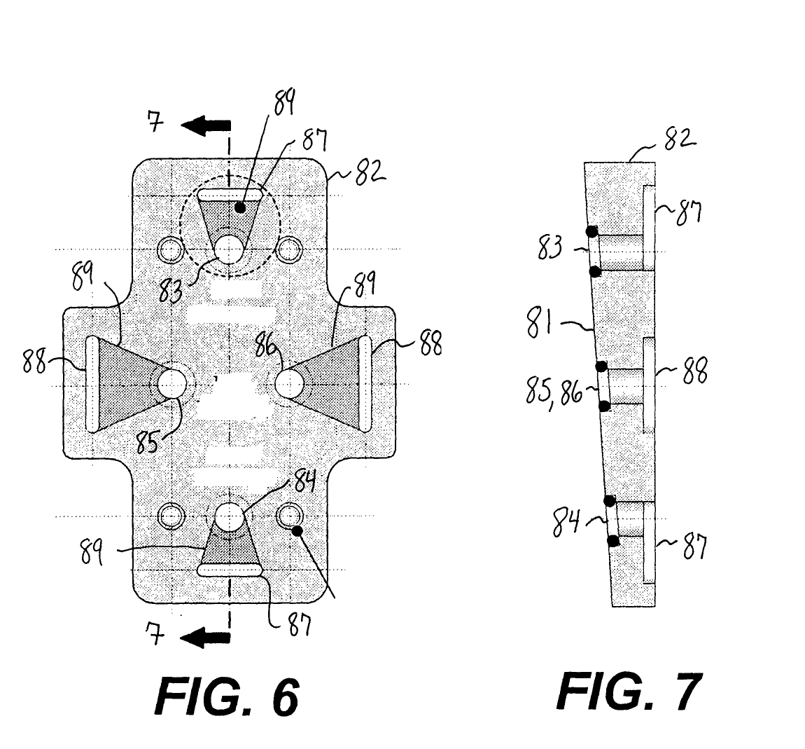

FIG. 5 is an end view of the fuel cell module 15 shown in FIG. 4 that shows the front mating face for a gas distribution manifold 82 of the module 15. The ports 83, 84 are for H₂ gas in and vent, respectively, and ports 85, 86 are for air in and air out. FIG. 6 is a view of the back mating face of the gas distribution manifold shown in FIG. 5 and FIG. 7 is a sectional view taken along line 7-7 in FIG. 6. The gas distribution channels 87 (H₂), 88(air) within the manifold are slot shaped (in cross section). The slots are rectangular in overall shape with rounded end portions that are approximately semicircular. Preferably, the rectangular dimensions are 4 to 1˜10 to 1 in length to width dimensions with semicircular end portions that have a diameter equal to the width dimension. The ports fan out as shown at 89 to connect with the slot shaped gas distribution passages as shown in FIG. 6.

As shown in FIGS. 4 and 7, the manifolds have a tapered side 81 with ports 83-86 having respective O ring seals for face to face connection with ports 41-44 in the headers. The respective ports of the headers and the manifolds are aligned with one another as shown in FIG. 3 when a module 15 is seated within a receiving section 55. Further, the insertion of the module 15 causes extension pieces 17 projecting outwardly from the handle to engage plunger actuators 65-68 of the spring loaded cartridge vales 60-63 as shown in FIGS. 1 and 2 (shown schematically in FIG. 2 just prior to engagement). When the handle extension pieces 17 depress the actuators 65-68, the valves 60-63 are opened from their normally closed position and the fuel gas and reactant gas (air) is supplied through the aligned ports to the manifolds of the module 15. Likewise, when the module 15 is removed from the receiving section 55, the spring bias of the valves forces the valves to the closed position to prevent escape of gas to the atmosphere. Further, insertion of the module 15 establishes electrical connection of the module 15 with the base 50 through electrical plugs 80 and mating sockets 79 provided in the base. Although both sides of the module 15 are shown to have tapered surfaces to achieve compression of the seals for engaging similarly tapered surfaces of the headers, only one side of the manifolds/headers could be tapered, however the preferred embodiment shows that both sides are tapered for ensuring equal compressive force distribution across the seals of the aligned ports to prevent leaks.

FIG. 8 is an end view of a collector end plate 98 for the fuel cell module 15 and FIG. 9 is a sectional view taken along line 9-9 in FIG. 8. There are two collector end plates 98, one at each end of the module 15 that are made of an electrically conductive material. All of the voltage generated by the module 15 is collected by the end collector plates 98, one cathode and one anode. Further, on only the internal face of each collector plate (facing the stack) grooving for gas distribution is provided. One plate has grooving for distribution of H₂ and the other plate has grooving for air distribution. Each plate has gas distribution passages 93 (H₂) and 94(air) and tie rod through holes 96, as shown in the figures. The through holes 96 are provided for the bolts or tie rods 5 that hold the module 15 together. The internal tie rods 5 are electrically isolated from each of the individual fuel cells and from the manifolds and collector end plates, which serve to establish a uniform compressive stress of, for example, <±1% over the active area of the cells within the module 15. Flanged bushings 97 in the collector plate through holes 96 also ensure electrical isolation of the tie rods and nuts for securing the plates together. The connection between the manifolds and the end plates are insulated also, as shown in FIG. 2.

Electrical plugs 80, such as banana plugs are threaded into one edge 91 of the plate as shown in FIG. 8. All of the voltage generated by the module 15 is collected by the end collector plates, one cathode and one anode and the plugs respectively transfer the current to the conductor strips 52, 53 in the base 50 of the assembly, as shown in FIG. 1. Accordingly, the base is also of a material that is an electrical insulator in order to accommodate the conductive bus strips.

FIG. 10 is a perspective view (exploded view) of the inside portions of a PEM fuel cell to be described for the purpose of illustrating an embodiment of fuel cell 25, which makes up the fuel cell module 15. This illustration depicts both a tie rod through hole pattern, located at the corners of the individual cell component elements, and a fuel and reactant gas distribution hole pattern located at mid-points between the tie rod through holes. Whereas circular gas distribution passages are shown in this embodiment, preferably the gas distribution passages 25a, 26a, 27a and 28a are slot shaped in cross section with rectangular dimensions that are 4 to 1˜10 to 1 in length to width dimensions and with semicircular end portions that have a diameter equal to the width dimension.

referring to FIG. 10, a module 15 typically has 1 of the 40 cells utilized to generate a nominal 5-kW of output power of 25 VDC at 200 amperes. A single cell's overall thickness regardless of the size of the active area chosen for the design is approximately 0.080 inches, with an active area (darkened center portion of item number 23) of approximately 250 cm². An individual cell consists of an upper anode fuel gas distribution pattern as depicted in phantom dotted lines on the bipolar plate item 20a and a lower cathode reactant gas distribution pattern on the lower bipolar plate 20b positioned at right angles to that of the fuel gas distribution pattern. Sandwiched between these two plates are a membrane electrode assembly (MEA) 23, which is itself sandwiched between a set of rigid non-conductive gaskets 21 with associated gas diffusion media (GDM) 22. The benefit of slotted gas distribution channels is described in U.S. application Ser. No. 10/393,919, which is hereby incorporated herein by reference.

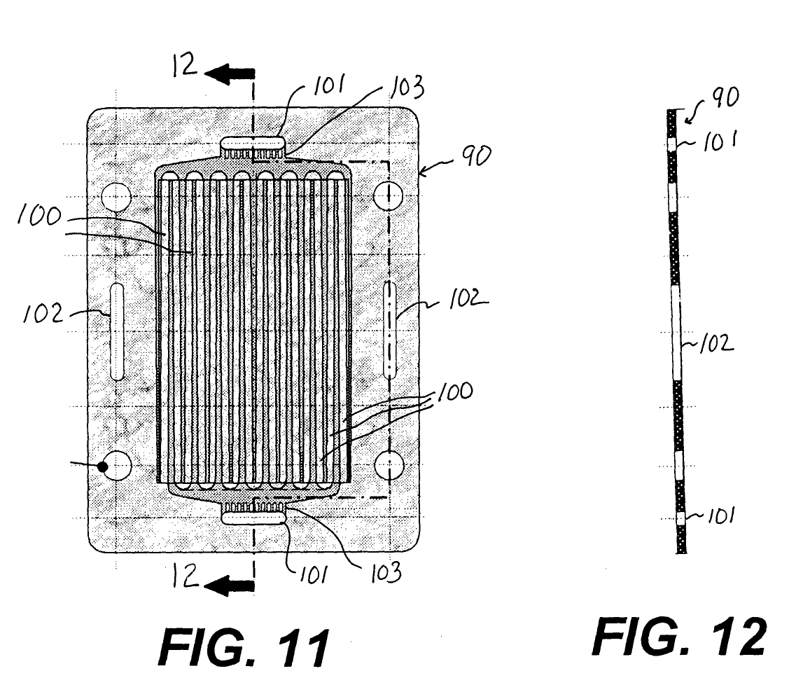

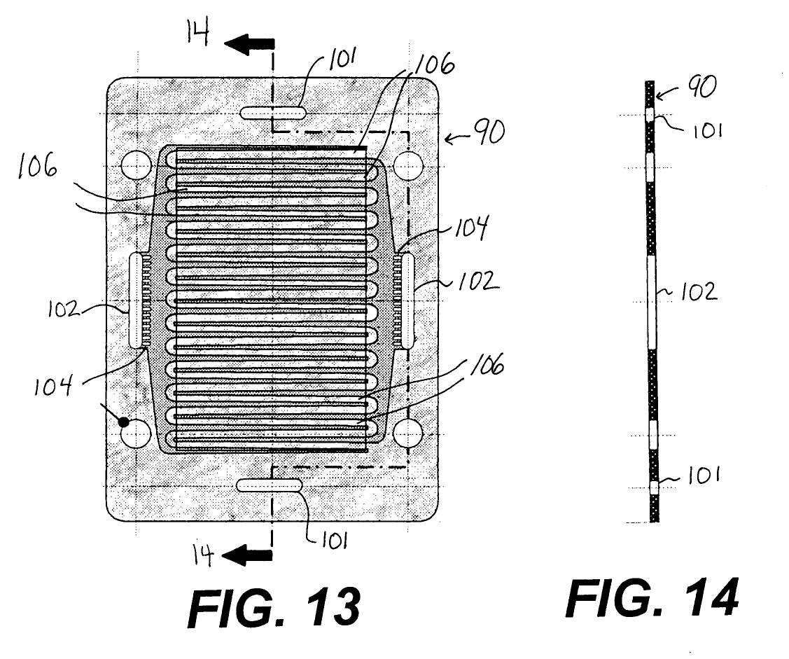

A preferred embodiment of a bipolar plate 90 is shown in FIGS. 11-14. The bipolar plates are used in conjunction with precision thickness, rigid, non-metallic gaskets to achieve the compressive deformation of the Gas Diffusion Media, such that both through-plane and in-plane gas permeability characteristics are precisely controlled between a plurality of cells within a fuel cell module 15 or stack, and within an individual cell itself. FIGS. 11 and 12 show the anode side of the bipolar plate 90 whereas FIGS. 13 and 14 show the cathode side of the plate.

The bipolar plate shown in FIGS. 11-14 has closely-spaced (interdigitated) tapered-width grooves 100 (H₂), 106 (air) possessing “large” groove depth in relation to the characteristic width, from 0.5× to 1× that of the minimum width dimension. The tapered-width groove facilitates the establishment of a highly uniform gas flow per unit area, by assuring, via the use of a “mirror-image” adjacent tapered grooving, that the inlet pressure drop is identically the same as the outlet pressure drop, regardless of the unit area being considered within the total active area of the cell. In one embodiment, the gas flow path lengths, and associated restrictive losses, are identically the same or very similar for any successive unit area's inlet pressure drop plus that of the outlet pressure drop.

The bipolar plate 90 shown in FIGS. 11-14 has gas distribution header slots 101 (H₂), 102 (air) that are used in the present invention, rather than holes, which are typically used in the prior art. The slots, are adjacent associated “gates” 103 (H₂), 104 (air) consisting of a plurality of closely spaced standoffs adjacent to the inlet and/or outlet of the slot. This facilitates the generation of controlled inlet and/or outlet pressure drop, which is significantly greater than the pressure drop that exists within the distribution header itself. The resultant effect is analogous to “desensitizing” an individual cell within a fuel cell module 15 from pressure gradients in the inlet and outlet distribution header pressure levels. This resultant effect is further described as creating a condition wherein each cell is connected to a gas distribution header with an “apparently” constant inlet pressure and/or back pressure, regardless of the cell's location within the module 15, such that each and every cell within the fuel cell module 15 “sees” an identically same or very similar differential pressure existing across the cell. The net effect is to establish an operational state whereby each cell is able to consume identically or nearly the same amount of either fuel or reactant gas (presupposing that each cell possesses approximately the same gas flow volume per pressure drop resistance characteristic).

The bipolar plate design approach shown in FIGS. 11-14 is further depicted by the use of a tapered-width distribution header, which is utilized to feed the plurality of closely-spaced (interdigitated) tapered-width grooves. The net effect of employment of this header configuration is to realize a condition of essentially constant inlet pressure and/or outlet pressure, such that a high degree of gas flow volume uniformity may be achieved over the entire active area of the cell itself, by, for example, the virtual elimination of any pressure gradient that might have existed from the center of the header to the outermost portion of the header if a non-tapered width header configuration (or similar) were employed.

The bipolar plate design approach shown in FIGS. 11-14 is achieved by fabricating the pattern of grooves 100, 106 and gates 103, 104 with control of the associated groove depths via a process of photo-engraving or similar conventional method. It is possible to tailor the bipolar plate design configuration to the Gas Diffusion Media (GDM) permeability characteristic by observing that the grooving depth dominates the gas flow versus pressure drop characteristic of the individual tapered-width grooves. That is, the flow volume per unit time is proportional to the product of the values of the third power of the depth dimension and the pressure drop. It may therefore be seen that, for GDM materials possessing a relatively low permeability, the present invention allows reduction in the required grooving depths. Conversely, if the GDM material has a high permeability, then the grooving depths can be increased in order to maintain an essentially constant delivery or return pressures within the respective “headers” (e.g., the tapered-width grooves).

The resultant bipolar plate design, in accordance with embodiments of the present invention, facilitates the use of the GDM's through-plane and in-plane permeability factors to yield a highly consistent gas flow volume per unit area resistance effect, which thereby allows it to generate a highly uniform (e.g., identical) pressure drop for any specific unit area region, as supplied by its associated inlet and outlet tapered-width grooves. A highly uniform flow volume per unit area is consequently achieved. This consistency in the GDM material resistance (gas flow volume per unit area versus the pressure drop) is primarily realized by use of the precision rigid gaskets (see, e.g., FIG. 10) within each cell configuration to control the overall thickness variation of the compressed GDM to a very high tolerance, typically less than ±0.00025″, for example, over the entire active area of the cell configuration. Additionally, this “as-realized” compressed thickness of the GDM also provides a controlled, highly consistent, minimum value for the resultant resistivity (Ohms-cm²). This resistivity may readily be determined via Micro-Ohm Meter measurements of a test sample GDM's electrical resistance (Ohms×Sample Size, cm²) versus its imposed compressive stress. One net effect of using precision gaskets is to facilitate the achievement of a highly consistent cell resistivity per unit area (by a precise control over the GDM deformation, and subsequent level of compressive stress) and to simultaneously realize an optimally low value for the resultant GDM resistivity. This yields the lowest possible value for cell resistivity, as measured by the effects of the individual cell's MEA, its electrodes, GDMs, and associated Bipolar Plates.

In conjunction with the previously identified capability to achieve a highly uniform gas flow volume per unit area, it can subsequently be demonstrated that a highly consistent electro-chemical process may be established per unit area, with electro-chemical plus electro-osmotic processes, including stoichiometric fuel and reactant gas states and operating conditions, that is virtually identical from anyone unit area to another unit area within the active region of a cell. The resultant configuration therefore yields greatly reduced susceptibility to “hot-spot” generation, and allows the establishment of a highly uniform current density over the entire active area of the cell. Furthermore, it may also be demonstrated that this same consistency exists between any successive cell within the fuel cell stack, and that the resultant variations in the measured cell to cell output voltages may be kept to very small values (e.g., <±0.010 V DC).

While preferred embodiments have been set forth with specific details, further embodiments, modifications and variations are contemplated according to the broader aspects of the present invention, all as determined by the spirit and scope of the following claims.

I claim:

1. A modular fuel cell power generation system, comprising:
a plurality of modular fuel cells and receiving sections, each of said modules having fuel cells in a stack between electrically conductive end plates and at least as many receiving sections in a base assembly having electrical bus strips and fuel gas and air distribution headers;
each of said modules further having manifolds adjacent said end plates having ports and internal passages connected to the ports for gas flow in supply and return passages providing uniform supply of fuel and reactant gases to each said fuel cell in said modules;
said headers having spring loaded valves for respective ports that supply fuel gas and air and that vent reactive gas and air, respectively, with an actuator for each said valve that is engaged by insertion of said module within said receiving section when said ports of said manifolds and corresponding ports of said headers are aligned; and
said modules having electrical connection said end plates and said base when said module is inserted in said receiving section.

2. A modular fuel cell power generation system, according to claim 1, wherein said headers and said manifolds each have sides that engage one another in which said ports are disposed and each of said sides is tapered to wedge said module in between said headers of said receiving section to establish a compressive force that maintains a face seal between said aligned ports when said module is inserted in said receiving section.

3. A modular fuel cell power generation system, according to claim 1, wherein said end plates have electrical plugs protruding outwardly from said module toward said base of said receiving section and said base has receptacles for receiving said plugs when said module is inserted in said receiving section.

4. A modular fuel cell power generation system, according to claim 1, wherein said electrical plugs engage said sockets with sufficient force to maintain said module in said receiving section.

5. A modular fuel cell power generation system, according to claim 1, wherein said tapered sides of said manifolds and said headers have a matching taper angle of approximately four degrees.

6. A modular fuel cell power generation system, according to claim 1, wherein said modules have a handle with portions of the handle engaging the actuators of said valves when said module is inserted in said receiving section to open gas flow through said valves.

7. A modular fuel cell power generation system according to claim 1, further including each said fuel cell including a bipolar plate having anode and cathode gas feed sides each having grooves for supplying gas within an individual cell;
said grooves having tapered-width micro-channel grooving that provides a significantly improved level of fuel and reactant gas distribution uniformity over the active area of each said cell.

8. A modular fuel cell, comprising:
a plurality of fuel cells in a stack between electrically conductive end plates, each said fuel cell including a bipolar plate having anode and cathode gas feed sides each having grooves for supplying gas within an individual cell;
said grooves having tapered-width micro-channel grooving that provides a significantly improved level of fuel and reactant gas distribution uniformity over the active area of an individual cell.
